(19) United States
(12) Patent Application Publication
(10) Pub. No.: US 2025/0271979 A1
(43) Pub. Date: Aug. 28, 2025

(54) ZONING IN INTERACTIONS

(71) Applicant: Quantum Metric, Inc., Colorado Springs, CO (US)

(72) Inventors: Jason Samuel BRODIE, Colorado Springs, CO (US); Ryan Palmer DABLER, Colorado Springs, CO (US); Sean Jon DE LA TORRE, Dana Point, CA (US)

(73) Assignee: Quantum Metric, Inc., Colorado Springs, CO (US)

(21) Appl. No.: 19/065,384

(22) Filed: Feb. 27, 2025

Related U.S. Application Data
(60) Provisional application No. 63/558,553, filed on Feb. 27, 2024.

(51) Int. Cl. G06F 3/0483; G06F 16/9538; G06F 40/14; G06F 40/154

(52) U.S. Cl. CPC G06F 3/0483; G06F 16/9538; G06F 40/14; G06F 40/154

(57) ABSTRACT

Method provides for dynamically grouping a plurality of elements of page. Method includes receiving input that indicates one or more elements of page, to initiate zone; determining information about position and level in hierarchy of view structure of page for one or more elements based on input; generating selector based on information about position and level in hierarchy of view structure of page for one or more elements, the selector identifying element tree with respect to one or more elements; receiving user query input for element among one or more elements; based on user query input, transforming selector for one or more elements into sequence of characters; searching database using sequence of characters, to identify events corresponding to sequence of characters; and analyzing event data of identified events to determine one or more properties of user interactions with respect to the zone.

### CROSS-REFERENCE TO RELATED APPLICATION(S)

This application is a non-provisional of and claims the benefit of the filing date of U.S. Provisional Patent Application No. 63/558,553, filed Feb. 27, 2024, the disclosure of which is incorporated by reference herein in its entirety.

### BACKGROUND

The website developers and providers do not have a clear insight into how their audience is using and interacting with the web documents or web applications because web document content can be modified within the user's browser. Traditionally, the network to desktop browsers was viewed as dependable and adhering to fairly consistent and predictable performance patterns. In the new environment where users increasingly access data from any device, and over widely varying network conditions, the proposition that the performance is consistent is no longer valid.

Accordingly, providers, designers, operators, and web document creators seek an accurate and efficient way to capture how users interact with their web documents to playback and analyze the remote interactions. However, because of the large amount of permutations of how users can interact with an individual document or groups of documents on the website, accurately and timely capturing, analyzing, and presenting the relevant information representative of users' interactions with the websites remains problematic.

### SUMMARY

Embodiments of the present disclosure provide systems, methods, and apparatuses for addressing the above problems by providing for dynamically grouping a plurality of user interactions conducted with a page of an application that can be accessed from a website.

Some embodiments of the present disclosure include a method performed by one or more processors of a computer system. The method can include receiving information for elements of a page of an application accessed from a website, the elements being engaged in interaction sessions of users with the website. The information can be saved in a database and can include, for each of the elements, (1) information about a node for the element in a view structure of the page, the view structure having a hierarchical tree architecture, and (2) a hierarchical path from the node to a root of the view structure, where an event related to an element of the page is saved as a row including the hierarchical path for the element. The method can further include receiving information related to a selection of one or more elements of the page of the website; generating a sequence of characters specifying a placement of the one or more elements of the page; querying the database using the sequence of characters to identify rows including the sequence of characters; and analyzing the identified rows to determine a property of the interaction sessions.

Some embodiments of the present disclosure include a method performed by one or more processors of a computer system. The method can include obtaining captured data for user interactions with a page of an application accessed from a website during a network session; and storing the captured data in a database, where event data for each event related to an element of a plurality of elements of the page can be saved as a row including a hierarchical path to the element that is determined based on a view structure corresponding to the page, the view structure having a hierarchical tree architecture. The method can further include receiving a zone-originating input from a user, the zone-originating input indicating one or more elements of the page among the plurality of elements, to initiate a zone; determining information about a position and a level in a hierarchy of the view structure for the one or more elements based at least on the zone-originating input, using the hierarchical tree architecture of the view structure, to determine an element tree; receiving a user query input selecting an element included in the element tree; based on the user query input, generating a selector based on the information about the position and the level in the hierarchy of the view structure for the selected element, the selector matching the element tree; transforming the selector into a sequence of characters; searching the database using the sequence of characters, to identify events in the rows corresponding to the sequence of characters; and analyzing event data of the identified events to determine one or more properties of the user interactions with respect to the zone. The event data of the identified events can contain data about the one or more properties of the user interactions.

These and other embodiments of the disclosure are described in detail below. For example, other embodiments are directed to systems, devices, and computer-readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 illustrates an example of a distributed computer system according to at least one embodiment.

FIG. 2A shows a block diagram of an exemplary zoning system, in accordance with some embodiments.

FIG. 2B shows an example of a portion of a document object model (DOM), in accordance with some embodiments.

FIG. 2C shows an example of constructing an element vein, in accordance with some embodiments.

FIG. 2D shows an example of constructing an element vein, in accordance with some embodiments.

FIG. 2E shows an example of constructing an element vein, in accordance with some embodiments.

FIG. 2F shows an example of a portion of a database, in accordance with some embodiments.

FIGS. 3A, 3B, 3C, and 3D show examples of selecting elements, in accordance with some embodiments.

FIG. 4 shows an example of selecting elements and generating selectors, in accordance with some embodiments.

FIG. 5 shows a simplified block diagram of a processing performed by a zoning system in accordance with various embodiments.

FIGS. 6A and 6B show a simplified block diagram of a processing performed by a distributed computer system in accordance with various embodiments.

FIG. 7 shows a block diagram of an exemplary computer system, in accordance with some embodiments.

### TERMS

Prior to describing embodiments of the disclosure, description of related terms is provided.

A “user” can be a person or thing that employs some other thing for some purpose. A user may include an individual that uses a user device and/or a website. The user may also be referred to as a “consumer” or “customer” depending on the type of the website.

A “user device” may include any suitable computing device that can be used for communication. A user device may also be referred to as a “communication device.” A user device may provide remote or direct communication capabilities. Examples of remote communication capabilities include using a mobile phone (wireless) network, wireless data network (e.g., 3G, 4G, 5G, or similar networks), Wi-Fi, Wi-Max, or any other communication medium that may provide access to a network such as the Internet or a private network. Examples of user devices include desktop computers, mobile phones (e.g., cellular phones), PDAs, tablet computers, net books, laptop computers, etc. Further examples of user devices include wearable devices, such as smart watches, fitness bands, ankle bracelets, etc., as well as automobiles with remote or direct communication capabilities. A user device may include any suitable hardware and software for performing such functions, and may also include multiple devices or components (e.g., when a device has remote access to a network by tethering to another device—i.e., using the other device as a modem—both devices taken together may be considered a single communication device).

A “server computer” may include a powerful computer or cluster of computers. For example, the server computer can be a large mainframe, a minicomputer cluster, or a group of computers functioning as a unit. In some cases, the server computer may function as a web server or a database server. The server computer may include any hardware, software, other logic, or combination of the preceding for servicing the requests from one or more other computers. The term “computer system” may generally refer to a system including one or more server computers.

A “processor” or “processor circuit” may refer to any suitable data computation device or devices. A processor may include one or more microprocessors working together to accomplish a desired function. The processor may include a CPU that includes at least one high-speed data processor adequate to execute program components for executing user and/or system-generated requests. The CPU may be a microprocessor such as AMD's Athlon, Duron and/or Opteron, etc.; IBM and/or Motorola's PowerPC; IBM's and Sony's Cell processor; Intel's Celeron, Itanium, Pentium, Xeon, and/or Xscale, etc.; and/or the like processor(s).

A “memory” or “system memory” may be any suitable device or devices that can store electronic data. A suitable memory may include a non-transitory computer readable medium that stores instructions that can be executed by a processor to implement a desired method. Examples of memories may include one or more memory chips, disk drives, etc. Such memories may operate using any suitable electrical, optical, and/or magnetic mode of operation.

A “web session” or “session” generally refers to a set of user interactions with a website. The session may include interactions starting with a user accessing a webpage of the website (e.g., using a web browser or other software application) and ending with the user ceasing interactions with the website (e.g., closing a webpage of the website within the web browser or software application). The time-length of the session in seconds, minutes, and/or hours can be determined based on a start time when the user first interacted with the website to an end time of the last interaction made by the user. The webserver hosting the website may store an identifier of the session and other information associated with the session (e.g., elements or items of the website selected by the user, or information input by the user).

A “session event” or an “event” can include an interaction or communication between a user device and a website. An event can refer to an event type (e.g., a definition) or to a specific instance of an event type, e.g., with an associated event ID that is sent from a user device to a detection system. The event can be defined by a client (e.g., an operator of the website). Events can be tracked and can be used as an input to a field (e.g., to a count of events of a particular type, an average value for an event) as part of defining a metric. As examples, an event can include click on a particular element, a modification with respect to an element, an amount of a transaction, a visit to a particular page of a website, a view of a page on a native application, etc. For example, an event can include a promo code or a discount associated with the promo code. As another example, an event can be the initiation of a web session, so that a number of web sessions can be tracked for the website.

A native application may refer to an application that is configured for a particular type of platform and/or particular type of device, e.g., a native environment on the device, as opposed to a browser that may download software to run locally on the device.

As used herein, a webpage may refer to a page of the application accessible from the website. Although examples in the present disclosure may refer to a webpage, such examples equally apply to any page of an application, such as a native application. Thus, a webpage may refer to a page of an application, including a native application.

A session may include one or more “stages” that a user progresses through until the user ends the session. The “stages” may be defined based on interactions made by the user (e.g., opening a webpage, selecting an element or item of the page, or inputting information in a particular location). For example, each stage may be associated with a particular interaction that is occurring during the stage (e.g., opening a page, selecting an element, or submitting data) and a particular interaction that ends the stage (e.g., opening another page, selecting another element, or submitting other data). Each stage may be associated with one or more changes or updates to a webpage (e.g., a visual change or a change in the information obtained by the web server). For example, each webpage of the website presented to the user may correspond to a different stage. In some examples, stages may be a combination of multiple different webpages and/or different interactions with particular webpages. Each of the stages may be associated with a unique identifier.

An example of a set of stages during a session is provided below. In this example, a user opens a homepage of a website, which is associated with a first stage. During the first stage, the user browses the page and selects a link to open a second page on the website, thereby ending the first stage and beginning a second stage. The second stage can be associated with the second page. During the second stage, the user browses the second page and inputs information to the second page by selecting items or elements of the page or by inputting text into a field of the second page. This information is submitted to the website (which can be performed automatically by the website or performed manually by the user selecting a submit button). The submission of such information can end the second stage and beginning a third stage. The third stage can be associated with a third page. The third page may present confirmation of the information selected or input by the user. Not every session with a particular website will include the same stages nor will the stages always occur in the same order. Different sessions may include different stages and the stages may occur in different orders. A particular stage or sequence of stages may occur more than once in a given session. In addition, while the stages are described as being associated with a particular “webpage,” the stages can be associated with particular in-line updates to blocks, fields, or elements of the same webpage (e.g., the same URL).

A “conversion” or “conversion event” generally refers to a digital interaction by a user that achieves a particular result or objective. For example, a “conversion” can include a user placing an order, registering for a website, signing up for a mailing list, opening a link, or performing any other action. As such, a mere “visitor” to a website has been converted into a “user” or “consumer” of the website. The conversion process may involve one or more intermediate actions taken by the user to achieve the result of objective. For example, a conversion process for placing an order can include the intermediate steps of visiting a website, selecting one or more items, adding one or more items to an order, selecting parameters for the order, inputting order information, and submitting the order. In another example, a conversion process for a user registering with a website can include the intermediate steps visiting the website, selecting a registration link, inputting an email address, and submitting the email address.

The term “machine learning model” may refer to a program, file, method, or process, used to perform some function on data, based on knowledge “learned” during a training phase. For example, a machine learning model can be used to classify feature vectors as normal or anomalous. In “supervised learning,” during a training phase, a machine learning model can learn correlations between features contained in feature vectors and associated labels. After training, the machine learning model can receive unlabeled feature vectors and generate the corresponding labels. For example, during training, a machine learning model can evaluate labeled images of dogs, then after training, the machine learning model can evaluate unlabeled images, in order to determine if those images are of dogs. In “unsupervised learning,” an ML model or algorithm is provided with unlabeled data, and is tasked to analyze and find patterns in the unlabeled data.

Machine learning models may be defined by “parameter sets,” including “parameters,” which may refer to numerical or other measurable factors that define a system (e.g., the machine learning model) or the condition of its operation. In some cases, training a machine learning model may include identifying the parameter set that results in the best performance by the machine learning model. This can be accomplished using a “loss function,” which may refer to a function that relates a model parameter set to a “loss value” or “error value,” a metric that relates the performance of a machine learning model to its expected or desired performance.

The term “providing” may include sending, transmitting, displaying or rendering, making available, or any other suitable method. While not necessarily described, messages communicated between any of the computers, networks, and devices described herein may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

### DETAILED DESCRIPTION

Embodiments can provide systems, methods, and apparatuses for dynamically grouping a plurality of user interactions conducted with a page of an application accessed from a website.

Users of websites and software applications can experience issues such as a delay in loading a webpage, software bugs, or interface design flaws that hinder them from taking certain actions (e.g., registering for a website or placing an order).

Techniques for identifying issues with websites may include monitoring, collecting, and analyzing session data, e.g., session events, related to the user interactions with the website.

A given webpage may include multiple zones including one or more elements. The monitoring software may be configured to collect the information for the zones and the analytics software may be configured to analyze the collected information that can be then made available for replay sessions.

In one technique, the ways in which the zones are defined are rigid, e.g., the boundaries of the zones are preset by a developer of the software. For example, if the user wants to see the metrics for the selected element on the screen, the zone for that element is predefined. In such technique, there is no flexibility for the user to redefine the zone to include only the desired element(s) or element(s) outside of zone boundary rigidly defined by the software developer.

That is, in existing techniques, it is difficult to variably define the zones so that the information related to the zone is flexibly collected for the replay session.

In the disclosed techniques, the zone can be dynamically defined by the end user. In an embodiment, the captured data may be collected for a time period. As an example, the captured data includes information related to the elements displayed on the screen, e.g., information about the elements that received a mouse click, information about the elements that received a mouse hovering, information about the time period the elements were displayed to the end user, etc. Here, the elements include images, icons, text, prompts, banners, characters, picture elements, etc.

Based on a user input on the displayed element in the UI (e.g., a mouse click on an image, icon, text, etc.), the system dynamically builds the zone including a plurality of elements around the click and connects the collected captured data to the zone on the fly. This is in contrast to the current techniques where the position of the selected element cannot be traced back to the view structure and the nodes associated with the selected element are unknown.

As used herein, the view structure means a data structure having a hierarchical tree architecture, e.g., a data structure of a page. A non-limiting example of the view structure is a DOM. Accordingly, for simplicity of description, embodiments below are described with reference to DOM. However, this is not intended to be limiting and other view structures having hierarchical tree architectures can be used.

In various embodiments, the user can, using a UI of the replay video, provide an input on the displayed element connected to a node in the data structure, e.g., a DOM. The system then creates a zone using the neighboring nodes of the DOM based on the rules. The system may further assign a zone identifier to the zone. As the system aggregates user interactions with a webpage, e.g., the events or the event data, the information is stored, e.g., in the table or the database, including the information for the zone. The system then can retrieve the user interactions within the arbitrarily defined zone, e.g., based on a user query input identifying at least one element included in the zone.

As mentioned above, the zone configuration starts with the user input selecting the element displayed in the replay session. The position and the hierarchy of the selected element in the DOM according to the user selection is known through the association of the selected element and the node in the DOM, e.g., the hierarchy information of the DOM includes information about a position of the selected element. Herein, the position of the DOM element is a horizontal position, e.g., among the siblings of the same level, and the hierarchy of the element in the DOM means the level with respect to the root. The one or more additional nodes may be identified based on rules, where a cascading sheet style (CSS) selector may be used to tag additional nodes to be included in the zone. The system then may collect and store the information, e.g., user clicks for the zone. The information may be then retrieved for the newly defined zone based on a query.

Accordingly, the zone construction begins with the node corresponding to the element selected by the user input, e.g., with the origin node corresponding to the origin element. The DOM is searched for the ancestors of the origin node up to the root of the DOM, thereby an element vein (e.g., an element tree) is identified and has a specific structure. Each of the nodes is associated with the HTML descriptions.

In an embodiment, an element-vein technique is applicable to a website capture as well as to an analysis of native applications executing in a native environments (e.g., iOS, Android, etc.).

The system captures information about each of the nodes and the associated HTML descriptions. The captured data is saved, e.g., in a table or a database, and includes information about each of the nodes included in the element vein and the associated HTML descriptions for the nodes.

The shape (e.g., structure) of the element vein is coupled to the generation of the queries against the data of the element vein.

For example, when the query is made for the zone based on the user input (e.g., a click in the webpage), the CSS selector corresponding to the query (e.g., click), which corresponds to the DOM architecture for a given zone (e.g., an element vein), is created. The CSS selector is then transformed into a search regular expression (regex) to be mapped to the element vein, to identify the associated zone and recognize that the click was received within the zone. The search regex is generated in a form compatible with the captured data stored in the database so that a search of the database for the data corresponding to the particular zone can be performed.

The disclosed techniques allow for zones overlap. For example, one zone may be configured as a higher level zone, and a separate zone may be configured as a lower level zone of the higher level zone, thereby producing an overlap zone in the lower level part of the higher level zone. In such configuration, the interactions (e.g., clicks) of the users in the lower level zone count toward both zones because the zone definition is arbitrary and the system can accurately determine the click happening under the same parent.

In certain implementations, the end user may configure N number of zones that are to be analyzed on the webpage. The CSS selector is then created for each zone selected to be analyzed, e.g., based on a user query input. The CSS selector for the zone describes how much of the webpage (e.g., webpage elements) is in the zone, for example, by taking into consideration the siblings and ancestors of a given origin node. After the CSS selector for the zone is created, the CSS selector corresponding to the received query is transformed into the search regex such that it perfectly matches the element vein and reflects the vertical and horizontal relationships among the nodes.

Although embodiments described with reference to the CSS selectors, the described techniques are not limited to the CSS selectors. For example, the selectors can be native selectors.

### I. DISTRIBUTED COMPUTER SYSTEM

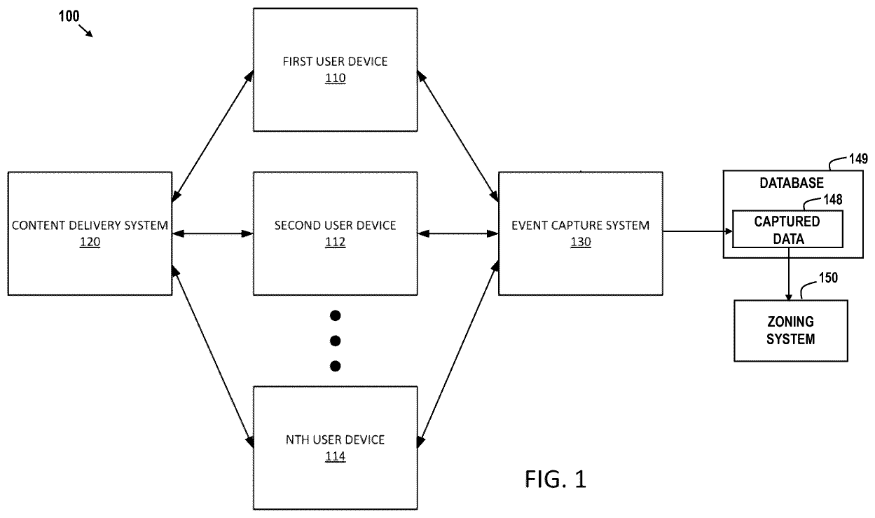

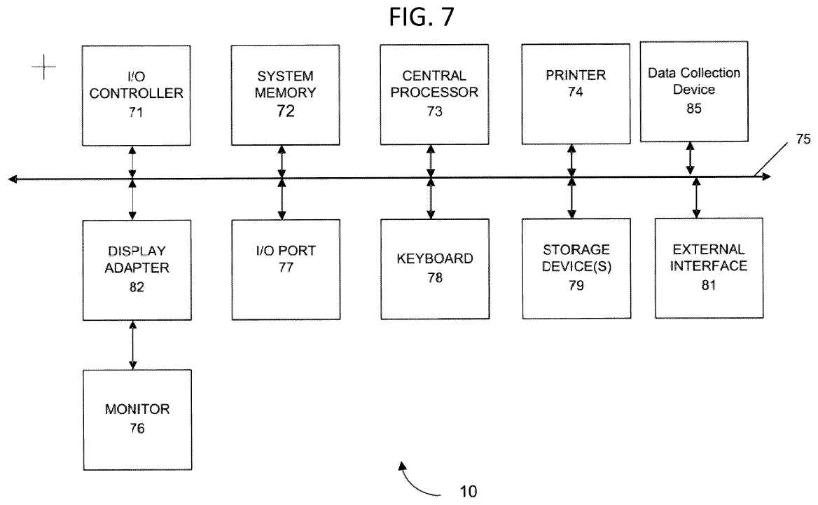

FIG. 1 illustrates an example of a distributed computer system 100 for analyzing a website performance according to certain embodiments. The distributed computer system 100 may be implemented using one or more computer systems, each computer system having one or more processors. The distributed computer system 100 may include multiple components, devices, systems, and/or subsystems communicatively coupled to each other via one or more communication mechanisms. For example, in the embodiment shown in FIG. 1, the distributed computer system 100 includes a content delivery system 120, an event capture system 130, and a zoning system 150. These systems may be implemented as one or more computer systems. The systems, subsystems, and other components shown in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The distributed computer system 100 shown in FIG. 1 is merely an example and is not intended to unduly limit the scope of embodiments. Many variations, alternatives, and modifications are possible. For example, in some implementations, distributed computer system 100 may have more or fewer systems or components than those shown in FIG. 1 or may have a different configuration or arrangement of systems. The systems shown in FIG. 1 may be implemented using one or more computer systems, such as the computer system shown in FIG. 7.

The distributed computer system 100 may include one or more user devices, such as a first user device 110, a second user device 112, and an Nth user device 114. Each of the one or more user devices may be operated by a different user. For example, a user may be using an application for presenting content on a user device. The application may be a browser for presenting content from many different sources using uniform resource locators (URLs) to navigate to the different sources or an application associated with a defined number of one or more sources (e.g., an enterprise application for content associated with an enterprise).

The content delivery system 120 may be implemented to store content, such as electronic documents (e.g., a collection of web documents for a website). In one illustrative example, content delivery system 120 may be a web server that hosts a website by delivering the content.

The one or more user devices (e.g., first user device 110, second user device 112, and Nth user device 114) may communicate with content delivery system 120 to exchange data via one or more communication networks. Examples of a communication network include, without restriction, the Internet, a wide area network (WAN), a local area network (LAN), an Ethernet network, a public or private network, a wired network, a wireless network, and the like, and combinations thereof.

In one illustrative example, the first user device 110 may exchange data with content delivery system 120 to send instructions to and receive content from content delivery system 120. For example, the first user device 110 may send a request for a webpage to content delivery system 120. The request may be sent in response to a browser executing on the first user device 110 navigating to a uniform resource locator (URL) associated with content delivery system 120. In other examples, the request may be sent by an application executing on the first user device 110

In response to the request, content delivery system 120 may provide the webpage (or a document to implement the webpage, such as a Hypertext Markup Language (HTML) document) to the first user device 110. In some examples, the response may be transmitted to the first user device 110 via one or more data packets.

While the above description relates primarily to providing webpages, it should be recognized that communications between user devices and content delivery system 120 may include any type of content, including data processed, stored, used, or communicated by an application or a service. For example, content may include business data (e.g., business objects) such as JavaScript Object Notation (JSON) formatted data from enterprise applications, structured data (e.g., key value pairs), unstructured data (e.g., internal data processed or used by an application, data in JSON format, social posts, conversation streams, activity feeds, etc.), binary large objects (BLOBs), documents, system folders (e.g., application related folders in a sandbox environment), data using representational state transfer (REST) techniques (referred to herein as “RESTful data”), system data, configuration data, synchronization data, or combinations thereof. A BLOB may include a collection of binary data stored as a single entity in a database management system, such as an image, multimedia object, or executable code, or as otherwise known in the art. As an example, content may include an extended markup language (XML) file, a JavaScript file, a configuration file, a visual asset, a media asset, a content item, etc., or a combination thereof.

The event capture system 130 may capture, store, provide, and regenerate events that occur on user devices. For example, a user device may display a webpage. In such an example, event capture system 130 may capture one or more interactions with the webpage that occur on the user device, such as movement of a mouse cursor, clicking on a certain button, activation of a user-selectable option, or the like. The capture system 130 may also capture timing values for different events for webpages of a website. As illustrated in FIG. 1, the event capture system 130 may be communicatively coupled (e.g., via one or more networks) to each of one or more user devices. For example, the event capture system 130 may be communicatively coupled to first user device 110. In some examples, instead of being separate from the user devices, an instance (not illustrated) of event capture system 130 may be executing on each of the user devices. In such examples, an additional portion of event capture system 130 may be separate from each of the user devices, where the additional portion communicates with each instance. In addition or in the alternative, event capture system 130 may be communicatively coupled to content delivery system 120 via a communication connection.

Each of first user device 110, second user device 112, Nth user device 114, content delivery system 120, event capture system 130, and/or zoning system 150 may include one or more computers and/or servers which may be general purpose computers, specialized server computers (including, by way of example, PC servers, UNIX servers, midrange servers, mainframe computers, rack-mounted servers, etc.), server farms, server clusters, distributed servers, or any other appropriate arrangement and/or combination thereof. Each of first user device 110, second user device 112, Nth user device 114, content delivery system 120, event capture system 130, and/or zoning system 150 may run any operating system or a variety of additional server applications and/or mid-tier applications, including HTTP servers, FTP servers, CGI servers, Java servers, database servers, and the like. Exemplary database servers include without limitation those commercially available from Microsoft, and the like.

Each of first user device 110, second user device 112, Nth user device 114, content delivery system 120, event capture system 130, and/or zoning system 150 may be implemented using hardware, firmware, software, or combinations thereof. In various embodiments, each of first user device 110, second user device 112, Nth user device 114, content delivery system 120, event capture system 130, and/or zoning system 150 may be configured to run one or more services or software applications described herein. In some embodiments, content delivery system 120, event capture system 130, and/or zoning system 150 may be implemented as a cloud computing system.

Each of first user device 110, second user device 112, Nth user device 114, content delivery system 120, event capture system 130, and/or zoning system 150 may include several subsystems and/or modules, which might not be shown herein. Subsystems and/or modules of each of first user device 110, second user device 112, Nth user device 114, content delivery system 120, event capture system 130, and/or zoning system 150 may be implemented in software (e.g., program code, instructions executable by a processor), in firmware, in hardware, or combinations thereof. The subsystems and/or modules of each of first user device 110, second user device 112, Nth user device 114, content delivery system 120, event capture system 130, and/or zoning system 150 may be implemented to perform techniques disclosed herein.

In some embodiments, the software may be stored in a memory (e.g., a non-transitory computer-readable medium), on a memory device, or some other physical memory and may be executed by one or more processing units (e.g., one or more processors, one or more processor cores, one or more GPUs, etc.). Computer-executable instructions or firmware implementations of the processing unit(s) may include computer-executable or machine-executable instructions written in any suitable programming language to perform the various operations, functions, methods, and/or processes disclosed herein.

Each of first user device 110, second user device 112, Nth user device 114, content delivery system 120, event capture system 130, and/or zoning system 150 may store program instructions that are loadable and executable on the processing unit(s), as well as data generated during the execution of these programs. The memory may be volatile (such as random access memory (RAM)) and/or non-volatile (such as read-only memory (ROM), flash memory, etc.). The memory may be implemented using any type of persistent storage device, such as computer-readable storage media. In some embodiments, computer-readable storage media may be configured to protect a computer from an electronic communication containing malicious code. The computer-readable storage media may include instructions stored thereon, that when executed on a processor, perform the operations disclosed herein.

Each of first user device 110, second user device 112, Nth user device 114, content delivery system 120, event capture system 130, and/or zoning system 150 may also include or be coupled to additional storage, which may be implemented using any type of persistent storage device, such as a memory storage device or other non-transitory computer-readable storage medium. In some embodiments, local storage may include or implement one or more databases (e.g., a document database, a relational database, or other type of database), one or more file stores, one or more file systems, or combinations thereof.

Each of first user device 110, second user device 112, Nth user device 114, content delivery system 120, event capture system 130, and/or zoning system 150 may provide some services and/or applications that are in a virtual or non-virtual computing environment. Such services may be offered on-demand to user devices. A user operating a user device may use one or more applications to interact and utilize the services or applications provided by content delivery system 120, event capture system 130, and/or zoning system 150. Services may be offered as a self-service or a subscription. Users may acquire the application services without the need for customers to purchase separate licenses and support. Examples of services may include a service provided under a Software as a Service (SaaS) model, a web-based service, a cloud-based service, or some other service provided to a user device. In some embodiments, event capture system 130 and/or zoning system 150 may host an application to interact with an application executing on a user device on demand. A user operating a user device may in turn utilize one or more applications to interact with content delivery system 120, event capture system 130, and/or zoning system 150 to perform operations described herein.

In some examples, a service may be an application service provided by content delivery system 120, event capture system 130, and/or zoning system 150 via a SaaS platform. The SaaS platform may be configured to provide services that fall under the SaaS category. The SaaS platform may manage and control the underlying software and infrastructure for providing the SaaS services. By utilizing the services provided by the SaaS platform, customers can utilize applications. The cloud computing system may be implemented as a cloud-based infrastructure that is accessible via one or more networks. Various different SaaS services may be provided.

A user device may include or be coupled to a display. A user device may provide access to one or more applications (also referred to herein as an “application program”). An application of the one or more applications may present content using the display. It should be recognized that an application may be executing on a user device, content delivery system 120, event capture system 130, zoning system 150, or a combination thereof. In some embodiments, an application may be accessed from one location and executed at a different location. An application may include information such as computer-executable or machine-executable instructions, code, or other computer-readable information. The information may be written in any suitable programming language to perform the various operations, functions, methods, and/or processes disclosed herein. The information may be configured for operation of the application as a program. Examples of applications may include, without restriction, a document browser, a web browser, a media application, or other types of applications.

In some embodiments, an application may be device specific. For example, the application may be developed as a native application for access on a particular device that has a configuration that supports the application. The application may be configured for a particular type of platform and/or particular type of device. As such, the application may be implemented for different types of devices. Devices may be different for a variety of factors, including manufacturer, hardware, supported operating system, or the like. The application may be written in different languages, each supported by a different type of device and/or a different type of platform for the device. For example, the application may be a mobile application or mobile native application that is configured for use on a particular mobile device.

In some embodiments, an application may generate a view of information, content, and/or resources, such as documents. For example, the application may display content to view on a user device. The view may be rendered based on one or more models. For example, a document may be rendered in the application, such as a web browser using a DOM. The view may be generated as an interface, e.g., a graphical user interface (GUI), based on a model. The document may be rendered in a view according to a format, e.g., a hyper-text markup language (HTML) format. The interface for the view may be based on a structure or organization, such as a view hierarchy.

Event capture system 130 may capture or record content presented by a user device. For example, the content may be a view of a document. Such content may be received from content delivery system 120. A view may be generated for display in the application based upon content obtained from content delivery system 120. In some embodiments, the application is a native application, written using a language readable by device to render a resource, e.g., a document, in the application. The view in the application may change rapidly due to one or more interactions with the application.

As described above, the event capture system 130 may be implemented at least partially on a user device (e.g., client-side) where views are to be captured. In such embodiments, event capture system 130 may be implemented in a variety of ways on the user device. For example, event capture system 130 may be implemented as instructions accessible in a library configured on the user device. Event capture system 130 may be implemented in firmware, hardware, software, or a combination thereof. Event capture system 130 may provide a platform or an interface (e.g., an application programming interface) for an application to invoke event capture system 130 or for event capture system 130 to monitor operations performed by a user device. In some embodiments, event capture system 130 may be an application (e.g., a capture agent) residing on a user device. Event capture system 130 may be implemented using code or instructions (e.g., JavaScript) embedded in an application.

An application for which views are to be captured may be implemented to include all or some instructions of event capture system 130. In such examples, event capture system 130 may be implemented for different types of devices and/or different types of platforms on devices. For example, event capture system 130 may be configured specific to a platform on a device so as to utilize specific functions of the platform to capture views in an application. In one example, an application may be configured to have instructions that are invoked in different scenarios to call event capture system 130. The application may include a capture management platform to invoke event capture system 130. In another example, the capture management platform may be embedded in the application. In some embodiments, the application may be implemented with instructions that invoke event capture system 130 through a platform or interface provided by event capture system 130. For example, different functions for generating views in an application may be configured to call event capture system 130. Event capture system 130 may monitor a view based on the call from the application, and then event capture system 130 may perform or invoke the original function(s) that were initially called by the application.

Event capture system 130 may monitor interactions with an application or content in the application to determine a change in the view. For example, event capture system 130 may determine when an interactive element (e.g., a field) changes and/or when a new view (e.g., an interface) or the existing view is presented. Event capture system 130 may also determine events associated with presenting a view in the application. The events may be determined using a model associated with displaying content, e.g., a document, in the application. The events may be identified by a node or other information in the model associated with the view. Examples of events include, without restriction, an interaction with the application or a change in a document displayed in the application.

Event capture system 130 may be implemented in different ways to capture the view in an application. Event capture system 130 may monitor a view to determine an organization of the view. The view may be monitored according to a variety of techniques disclosed herein. The view may be monitored to determine any changes in the view. The view may be monitored to determine the view, such as a view hierarchy of the view in the application, a layout of the view, a structure of the view, one or more display attributes of the view, content of the view, lines in the view, or layer attributes in the view. Monitoring a view may include determining whether the view is created, loaded, rendered, modified, deleted, updated, and/or removed. Monitoring a view may include determining whether one or more views (e.g., windows) are added to the view.

Event capture system 130 may generate data that defines a view presented by an application. Event capture system 130 may generate the view as a layout or page representation of the view. Data may describe or indicate the view. The data may be generated in a format (e.g., HTML) that is different from a format in which the view in the application is written. For example, for multiple applications that are similar, but configured for different native environments, the view from each of the applications may be translated by event capture system 130 into data having a single format, e.g., HTML. The language may have a format that is different from a format of the language in which the view is generated in the application. The language may be generic or commonly used such that a computer system can process the data without a dependency on a particular language. Based on the information determined from monitoring a view at a user device, event capture system 130 may generate the data having a structure and the content according to the structure as it was displayed at the user device. For example, the data may be generated in HTML and may have a structure (e.g., a layout and/or an order) as to how content was seen in a view, such as headers, titles, bodies of content, etc. In some embodiments that data may be generated in the form of an electronic document for one or more views. The data may be generated to include attributes defining the view such as display attributes of the content. The data may be generated to include the content that was visibly seen in the view according to the structure of the view. In some embodiments, data may be generated for each distinct view identified in the application.

The event capture system 130 can collect and output the captured data 148, e.g., the data points. The captured data 148 may include a list of user actions during the web session and/or interactions with one or more webpages of the web session. The captured data 148 may be stored in a database 149.

### II. ZONING SYSTEM

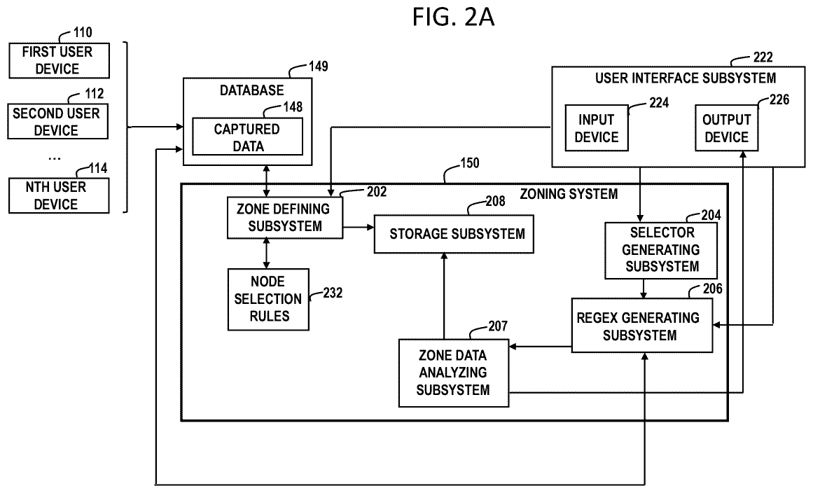

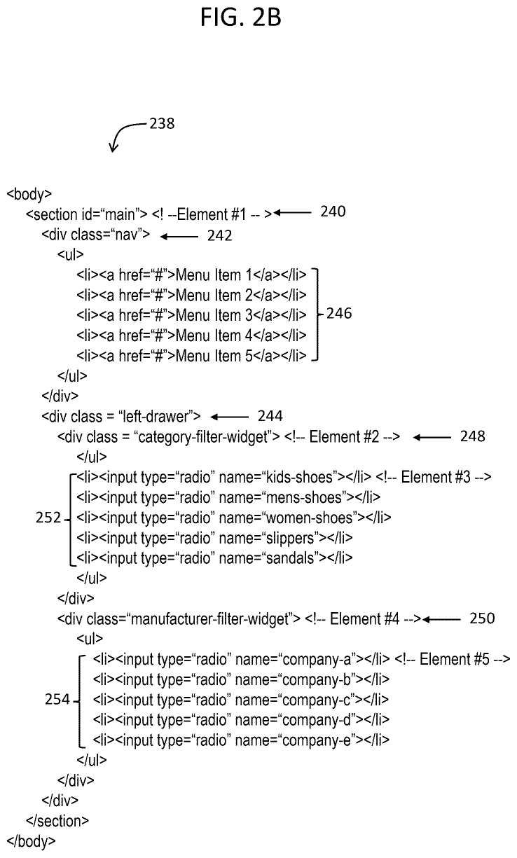

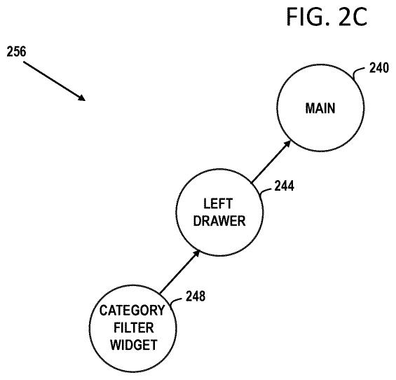

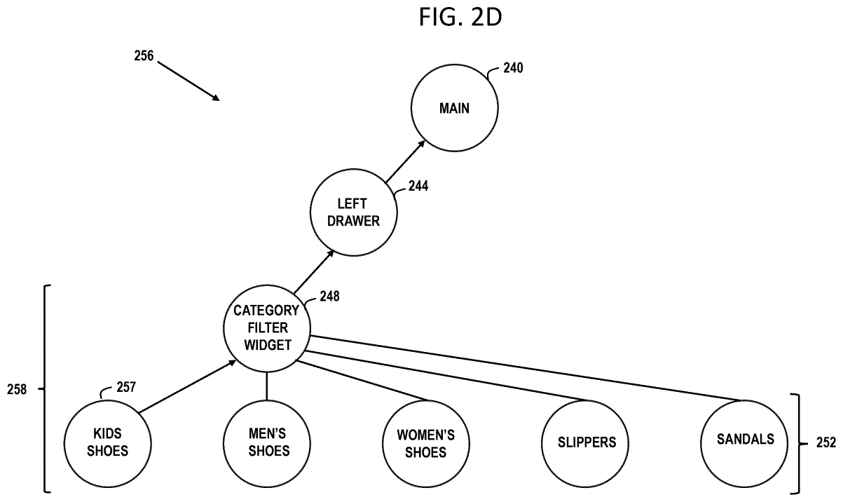

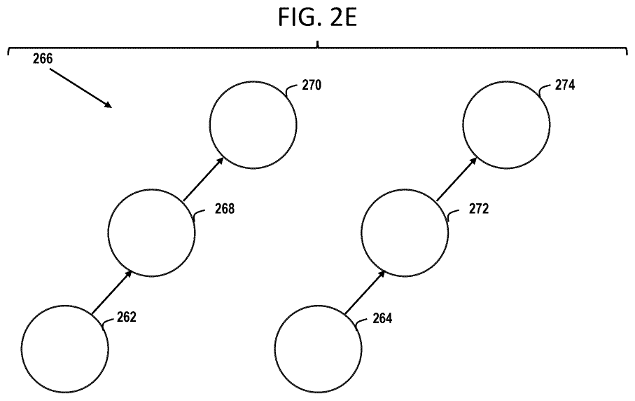

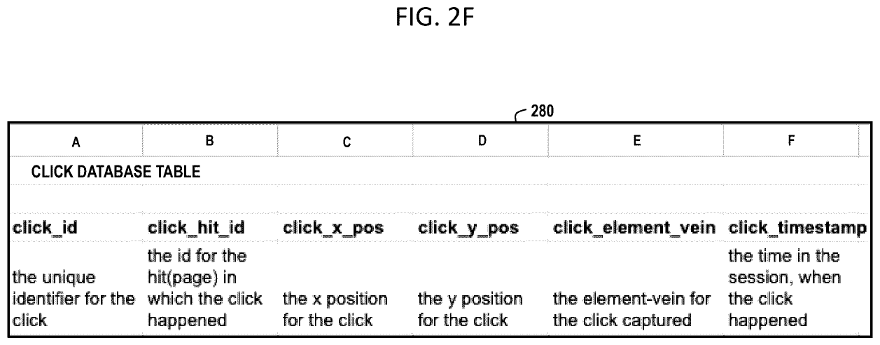

FIG. 2A is a simplified block diagram of a zoning system 150 according to certain embodiments. The zoning system 150 may be implemented using one or more computer systems, each computer system having one or more processors. The zoning system 150 may include multiple components and subsystems communicatively coupled to each other via one or more communication mechanisms. For example, in the embodiment shown in FIG. 2A, the zoning system 150 includes a zoning defining subsystem 202, a selector generating subsystem 204, a regex generating subsystem 206, and a zone data analyzing subsystem 207. These subsystems may be implemented as one or more computer systems. The systems, subsystems, and other components shown in FIG. 2A may be implemented in software (e.g., code, instructions, program) executed by one or more processing units (e.g., processors, cores) of the respective systems, using hardware, or combinations thereof. The software may be stored on a non-transitory storage medium (e.g., on a memory device). The zoning system 150 shown in FIG. 2A is merely an example and is not intended to unduly limit the scope of embodiments. Many variations, alternatives, and modifications are possible. For example, in some implementations, zoning system 150 may have more or fewer subsystems or components than those shown in FIG. 2A, may combine two or more subsystems, or may have a different configuration or arrangement of subsystems. The zoning system 150 and subsystems shown in FIG. 2A may be implemented using one or more computer systems, such as the computer system shown in FIG. 7.

As shown in FIG. 2A, the zoning system 150 also includes a storage subsystem 208 that is interfaced with one or more components of the zoning system 150 and may store the various data constructs and programs used by the zoning system 150.

The zoning system 150 can be interfaced with a user interface (UI) subsystem 222 including one or more input devices 224 for receiving a user input.

The UI subsystem 222 may be implemented in an electronic device such as a computer, a mobile phone, etc. In some implementations, the UI subsystem 222 may be implemented in one or more of the first user device 110 to the Nth user device 114, or the UI subsystem 222 may be implemented in the electronic device different from any of the first user device 110 to the Nth user device 114.

However, the described above is not intended to be limiting. For example, the UI subsystem 222 may be a component of the zoning system 150.

Although FIG. 2A illustrates only one input device 224, the UI subsystem 222 may include a plurality of input devices. The plurality of input devices may take any suitable form, e.g., buttons, keyboard, mouse, microphone, etc. The UI subsystem 222 may further include an output device 226 that may be a display screen. In some instances, the output device 226 may be a touch screen including a display screen for providing a display output and a touch pad serving as one of the input devices 224.

### A. Generating Zones

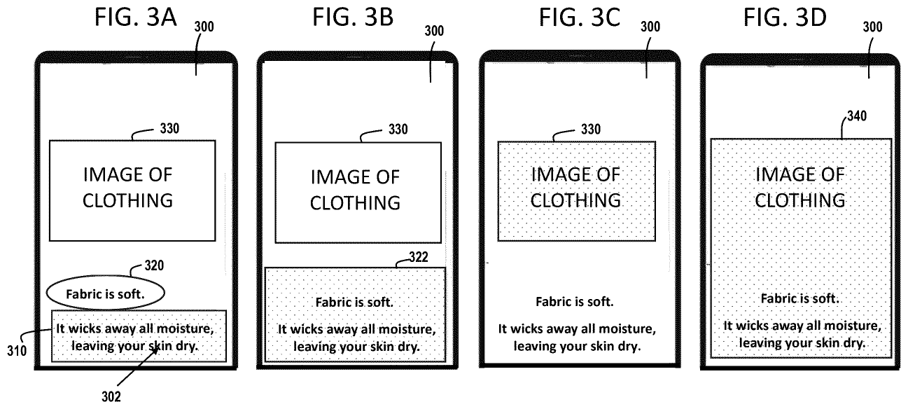

In some implementations, while the output device 226 displays an image on the display screen (e.g., corresponding to the replay session), a user may input, via the input device 224, a zone-originating input. The zone-originating input may be received from a user in response to the prompt asking the user to initiate the zone. The zone-originating input may be a selection input of one of the elements displayed on the display screen, such as text, an image, an icon, a prompt, etc. Optionally, another prompt may be displayed asking the user to confirm the selection, e.g., that the selection is completed. A non-limiting example of the zone-originating input (e.g., input 302) is shown in FIG. 3A that is described in detail below.

The signal corresponding to the selection of the element and coordinates of the selected element are provided to the zone defining subsystem 202.

The zone defining subsystem 202 may also receive, as an input, the captured data 148. For example, the captured data 148 can include information about the nodes of the DOM, where each node represents the element displayed on the display screen.

The zone defining subsystem 202 is configured to match the zone-originating input provided on one of the elements displayed on the display screen to a particular node in the DOM. An example of a portion of the DOM is shown in FIG. 2B and described below. As mentioned above, a non-limiting example of DOM is used for simplicity of description and other view structures having a hierarchical tree architecture can be equally used.

Herein, the node matched to the zone-originating input provided by a user through the UI subsystem 222 is referred to as an origin node.

The zone defining subsystem 202 may search the DOM to determine a collection of the nodes for the zone based on the origin node. For example, given as a starting point the origin node, the zone defining subsystem 202 determines which nodes of the DOM are to be included in the zone, by constructing an element vein using node selection rules 232.

The node selection rules 232 may be adapted to be at least partially customizable by the user. A customizable rule may be a rule to include into the zone the sibling nodes of the original node that are neighbors of the origin node. Another customizable rule may be a rule to include into the zone the ancestor nodes of the sibling nodes. However, this is not intended to be limiting. In some implementations, the user can have manual control of which elements and nodes to include in the zone by manipulating the input device or input devices 224 through the UI subsystem 222, e.g., by selecting certain element or elements displayed on the display screen and then providing a command by which the parent or parents of one or more elements are to be included. In some implementations, the user may further provide a command whether to include the siblings of the selected parent(s).

### 1. DOM

As mentioned above, the zone defining subsystem 202 may search the DOM to determine a collection of the nodes for the zone.

FIG. 2B shows an example of a portion of a DOM, e.g., nodes associated with HTML descriptions 238. The root node 240 (“main”) has two children nodes, e.g., nodes 242 and 244. A node 242 (“nav”, a first child node of “main”) has children nodes 246. A node 244 (“left drawer”, a second child node of “main”) has two children nodes, e.g., nodes 248 and 250. A node 248 (“category-filter-widget”, a first child node of “left drawer”) has children nodes 252. A node 250 (“manufacturer-filter-widget”, a second child node of “left drawer”) has children nodes 254.

### 2. Constructing a Zone

As described above, the zone defining subsystem 202 determines which nodes of the DOM are to be included in the zone, by constructing an element vein using node selection rules 232. For example, as a default rule, one rule may be to include into the element vein all the DOM nodes that are ancestor nodes to the origin node, as described below with reference to an example of FIG. 2C.

With reference to FIGS. 2B and FIG. 2C, the zone construction can begin with the node corresponding to the element selected by the user input, e.g., the origin node 248, “category-filter--widget.” The DOM is searched for the ancestor nodes (e.g., ancestor node 244, “left drawer”) of the origin node 248 up to the root node 240 of the DOM, thereby an element vein 256 (e.g., an element tree) is identified and has a specific structure. Each of the nodes of the element vein 256 is associated with the HTML descriptions 238, shown in FIG. 2B.

The information about each of the nodes of the DOM and the associated HTML descriptions for the nodes are captured and saved, in a table of a database, e.g., the database 149.

Accordingly, as described above, the information about each of the nodes of the element vein 256 and the associated HTML descriptions for the nodes can be found in the database 149.

Based on a user query input received in the replay on one of the elements that corresponds to an element in the element vein 256, the selector generating subsystem 204 may generate a CSS selector using the nodes of the element vein 256, e.g., using the HTML attributes of the nodes that can be then matched against the data of the element vein 256 that is stored in the database 149. The non-limiting examples of the attributes of the nodes may include class, identifier, title, name, position, alt, accessible rich internet applications (aria) attributes (e.g., aria-label), and any other appropriate attributes chosen according to the application.

### 3. Constructing Overlapping Zones

In embodiments, the zones can overlap. This is described below with reference to FIG. 2D. It is assumed that the zone corresponding the element vein 256 has been already constructed. This zone is referred to as a higher level zone.

The construction of a lower level zone can begin with the origin node 257 corresponding to the element selected by the user input, e.g., “kids shoes.” The zone defining subsystem 202 determines which nodes of the DOM are to be included in the zone, by constructing an element vein using node selection rules 232. In this example, a rule may be to include into the element vein all the DOM nodes that are ancestor nodes to the origin node and also the siblings of the origin node.

The DOM is searched for the ancestor nodes (e.g., nodes 248, 244) of the origin node 257 up to the root node 240 of the DOM. The zone defining subsystem 202 includes into the zone the siblings of the origin node 257, i.e., the remaining children of the node 248. An element vein 258 (e.g., an element tree) is identified and has a specific structure. Each of the nodes of the element vein 258 is associated with the HTML descriptions 238, shown in FIG. 2B.

As described above, the information about each of the nodes of the element vein 258 and the associated HTML descriptions for the nodes can be found in the database 149.

Based on a user query input received in the replay on one of the elements that corresponds to an element in the element vein 258, the selector generating subsystem 204 may generate a CSS selector using the nodes of the element vein 258, e.g., using the HTML attributes of the nodes that can be then matched against the data of the element vein 258 that is stored in the database 149, where the clicks received within the element vein 258 are counted as being received toward the element vein 258 and toward the element vein 256.

The zone construction of FIG. 2D allows for the zones to overlap, while both zones are independently created and assigned different zone identifiers. However, since the lower level zone corresponding to the element vein 258 is a part of a higher level zone corresponding to the element vein 256, the clicks received within the element vein 258 are counted as being received toward the element vein 258 and toward the element vein 256.

### 4. Constructing Zone Having Different Origin Nodes

In some implementations, the zone-originating input, which is received in response to the zone initiating prompt, may include a plurality of user selection inputs that select a plurality of elements on the display screen, where each of selected elements corresponds to an origin node of the DOM. Another prompt may be displayed asking the user to confirm the selection, e.g., that the selection is completed.

With reference an example of FIG. 2E, after the user confirms the selection, the zone defining subsystem 202 matches each of the plurality of elements corresponding to the plurality of user selection inputs received within the zone-originating input to a plurality of nodes in the DOM, where each of the plurality of nodes within the zone-originating input corresponds to one of the nodes serving as the origin nodes 262, 264. For example, the DOM is searched for the ancestor nodes of the origin node 262 up to the root node 270 (e.g., ancestor nodes 268 and 270) and of the origin node 264 up to the root node 274 (e.g., ancestor nodes 272 and 274). An element vein 266 (e.g., an element tree) is identified and has a specific structure. Each of the nodes of the element vein 266 is associated with the HTML descriptions.

The information about each of the nodes of the DOM and the associated HTML descriptions for the nodes are captured and saved, in a table of a database, e.g., the database 149. Accordingly, the information about each of the nodes of the element vein 266 and the associated HTML descriptions for the nodes can be found in the database 149.

Based on a user query input received in the replay on one of the elements that corresponds to an element in the element vein 266, the selector generating subsystem 204 then may generate a CSS selector using the nodes of the element vein 266, e.g., using the HTML attributes of the nodes that can be then matched against the data of the element vein 266 that is stored in the database 149.

### 5. Collecting Clicks

As mentioned above, the information about each of the nodes of the element vein 266 and the associated HTML descriptions for the nodes can be found in the database 149.

FIG. 2F shows an example of a portion of a table 280 of the database 149 where the clicks are collected. The table 280 can be a part of the captured data 148.

As illustrated, a row of the table 280 may include:
Click_id is a unique identifier for the specific click and is generated when the information about the click is inserted into the database 149.
Click_hit_id is the identifier of the page (e.g., an application page or a webpage) that is received the click.
Click_x_pos and click_y_pos are x, y coordinates of a position on the displayed page where the click is received.
Click_element_vein stores the element vein (and/or identifier for the element vein) for which the click is captured.
Click_timestamp is the time in session when the click happened.

As described above, the zones may be flexible and dynamically created, thereby an arbitrary collection of the user interactions with elements of the website can be obtained.

### B. Querying Zones

As described above, the distributed computer system 100 may collect information about the user interactions with the website. The information may be stored in the captured data 148, e.g., in the database 149.

For example, when a user wants to observe the data related to the operation of the website for the generated zone, the user can click on the element of the replay session displayed on the output device 226, thereby providing a selection input, e.g., a user query input. A query related to the selected element can be obtained from or generated based on the user selection input (e.g., click on the element). For example, the selector generating subsystem 230 can generate a CSS selector for the selected element, and the CSS selector can be used in the generation of the query as described below.

As another example, the user may provide, as a selection input, a CSS selector. For example, the user can type in the CSS selector into a prompt displayed on the output device 226.

The information related to the query (e.g., the CSS selector) can be provided to the regex generating subsystem 206.

The regex generating subsystem 206 transforms the CSS selector to a search regex to be mapped to the element vein that contains the zone where the query was received. The regex generating subsystem 206 generates the regex to search the database 149 for the data belonging to the zone.

The zone data analyzing subsystem 207 can then analyze the zone data, e.g., calculate metrics including various quantifiable factors on all previously collected clicks. The metrics can be displayed on the output device 226, e.g., as an overlay on the replay. In another example, the metrics can be transmitted to an external device or external devices over the network and displayed thereon, etc.

As described above, in certain implementations, the user may configure N number of zones that are to be analyzed on the webpage. Based on a subsequent query, the CSS selector is created for a corresponding zone and describes how much of the webpage (e.g., webpage elements) are in the zone. The CSS selector is then transformed such that it perfectly matches a corresponding element vein and reflects the vertical and horizontal relationships among the nodes of the DOM.

### C. Displaying Metrics

In an embodiment, a zoning interface for presenting a webpage with performance information for zones in a webpage may be provided on the output device 226. As discussed above, zones refer to the various content elements, fields, and other web components that form the portions of a webpage or website. As an example, an online shopping website may include a search bar, a “go to cart” button, and a “home page” button, where the search bar and the various buttons are within a zone defined by a user. The captured data can be collected for some period of time, prior to the user defining the zone, concurrently therewith, and/or subsequently. The captured data includes the data for the zone. At user's request, the performance metrics can be generated and provided on the replay video via the output device 226.

With regard to the zones defined by the user, the metrics may be overlaid on the zones, or aggregate metrics can be plotted on a timeline.

The metrics for the zone can include information about abandoned carts value, conversion carts value, average session duration, average time to first click on the page, click rate (e.g., a click per minute), click recurrence (e.g., on the same element), conversions value, converted session rate, and/or page click rate. However, this is not intended to be limiting. In embodiments, any metric regarding a session could be composed and correlated to the zones.

As used herein, the value(s) of the metrics refer to a property associated with an interaction session of a user with a website.

In embodiments, the data collected for the zone can be further filtered (segmented) via one or more criteria. For example, certain data can be specifically included and certain data can be excluded. Referring again to FIG. 2D, a user can specify to display metrics only with respect to node 257, “kids shoes,” by providing a query. As a result, the interactions (e.g., mouse clicks) on all other elements on the page would be excluded from analytics.

As another example, only view clicks from a particular browser can be included in the analytics.)

### III. EXAMPLES

Below, examples(s) of creating the zone are provided.

### A. Example of Designating Origin of the Zone

FIGS. 3A to 3D show an example of selecting elements to be included in a zone. For example, the rule, based on which the elements are selected, may be a rule to include all of the siblings of selected element. As another example, a collection of origin elements may be created by the user input selecting the elements displayed on the UI subsystem 222, e.g., in a replay.

In FIG. 3A, a replay 300 can be displayed on the UI subsystem 222. A user input may be received, through the replay 300, on one or more words of a text 310. The user input may be an input 302 on the word skin that can serve as a zone-originating input. For example, upon receiving the input 302 on the word skin, the entire text 310 may be selected as an origin element for the zone. The text 320 and the text 330, which are disposed above the text 310, can be considered sibling elements of the text 310.

Although in the example of FIG. 3A the construction of the zone is described by referring to text, this is not intended to be limiting. In an embodiment, any element on the screen can be selected to start a zone, as described above.

As shown in FIG. 3B by a shaded area, the text 320 may be encapsulated together with the text 310 as shown by a reference numeral 322. In this example, reference numeral 322 is an origin element for the zone, so that the text 320 and the text 310 share a common ancestor. In this example, the metrics (e.g., clicks count) can be obtained for both sibling elements (i.e., the text 320 and the text 310) because these sibling elements are encapsulated within the parent represented by the reference numeral 322.

As shown in FIG. 3C by a shaded area, the text 330 is also selected for the zone.

As shown in FIG. 3D by a numeral reference 340, an origin of the zone is created. The origin of the zone includes three elements, e.g., text 310, text 320, and text 330.

### B. Example of Creating CSS Selectors

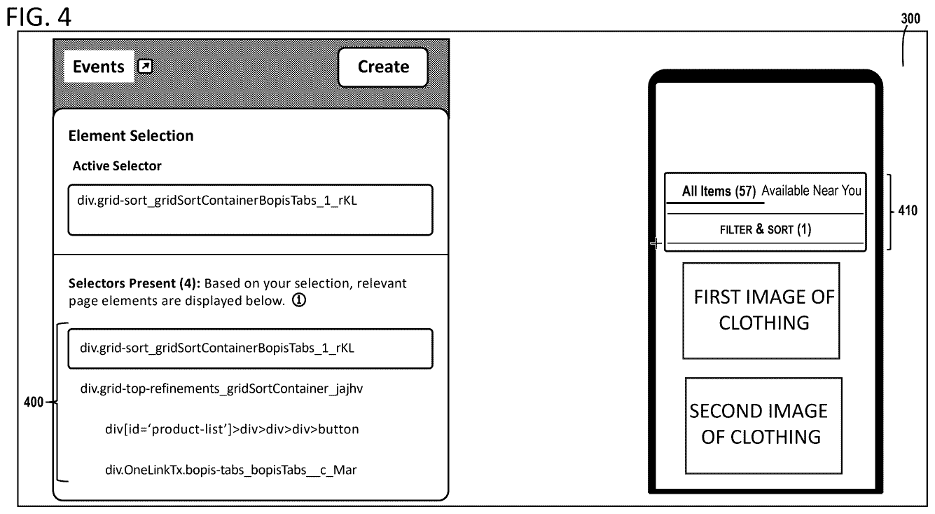

FIG. 4 shows an example of CSS selectors 400 generated based on the user selecting, e.g., highlighting, mouse clicking, etc., a zone to include a plurality of elements, e.g., FIG. 4 illustrates an example of bulk-creating the zone. For example, after the user selects an area 410, the selector generating subsystem 204 may generate a CSS selector (“active selector”).

### C. Examples of Collecting and Retrieving Information for Zones

The following examples illustrate examples of (i) the data captured for the element vein when the zone-originating input is received, (ii) subsequently received CSS selector, and (iii) regex generated by transforming the CSS selector. The data captured for the element vein may be stored in column E of FIG. 2F.

### Example 1

After the zone-originating input is received on one of the elements of the replay, the zone is determined as described above and associated with the element vein having a specific identifier.

The data captured for the zone, e.g., based on the zone-originating input, may include properties/attributes of the nodes as in an example below:

HTML[class=“os-default”]:last-child:nth-child(0):only-child>BODY:last-
child:nth-child(1)>DIV[id=“root”]:nth-child(1)>DIV[class=“category-css
document-page page-wrapper”]:nth-child(1)>DIV[class=“main-wrapper”]:nth-
child(2)>MAIN[class=“main-content”][id=“content”]:last-child:nth-
child(1)>ARTICLE[class=“main-page-content”]:last-child:nth-child(0):only-
child>DIV[class=“section-content”]:nth-child(1)>P:nth-child(0)

The user then can input a CSS selector into a text field displayed on the UI subsystem 222 as follows:

#root p

The regex generating subsystem 206 may transform the input CSS selector (e.g., #root p) into search regex:

\[id=“root”\].*?p

The database 149 can then be searched using the regex to retrieve collected information.

Examples 2 and 3 below follow the similar processing after a corresponding zone is determined.

### Example 2

The data captured for the zone, e.g., based on the zone-originating input, may include properties/attributes of the nodes as in an example below:

html[class=“carousel os-default zany”]:last-child:nth-child(0):only-child

The user then can input a CSS selector into a text field displayed on the UI subsystem 222 as follows:

User input(CSS selector):[class*=“os-default”]

The regex generating subsystem 206 may transform the input CSS selector into search regex:

Search regex:[\hat{ }>]*\[class=“[\hat{ }”]*os-default[\hat{ }“]*”\]

### Example 3

The data captured for the zone, e.g., based on the zone-originating input, may include properties/attributes of the nodes as in an example below:

html[class=“os-default”]:last-child:nth-child(0):only-child>body:last-child:nth-
child(1)>custom-element[id=“root”]:nth-child(1)>div[class=“category-css
document-page page-wrapper”]:nth-child(1)>div[class=“main-wrapper”]:nth-
child(2)>main[class=“main-content second-class”][id=“content”]:last-child:nth-
child(1)>article[class=“main-page-content”]:last-child:nth-child(0):only-
child>div[class=“section section-content”]:nth-child(1)>b:nth-child(0)

The user then can input a CSS selector into a text field displayed on the UI subsystem 222 as follows:

User input(CSS selector):main>.main-page-content>.section-content.section

The regex generating subsystem 206 may transform the input CSS selector into search regex:

Search regex: (\hat{ }|>)main[\hat{ }>]*>[\hat{ }>]*\[class=(″|.+? )main-page-content(″\]|
[\hat{ }″]+″\])[\hat{ }>]*>[\hat{ }>]*\[class=(″|.+? )section [\hat{ }″]*\bsection-content(″\]|
[\hat{ }″]+″\])

Although examples 1 to 3 describe that the CSS selector is input by a user, this is not intended to be limiting. For example, the CSS selector can be generated by the selector generating subsystem 204 based on a user query input for a respective element.

Although embodiments above are described with reference to the CSS selector(s), the described techniques are not limited to the CSS selectors. For example, the selector(s) can be native selector(s).

IV. METHODS

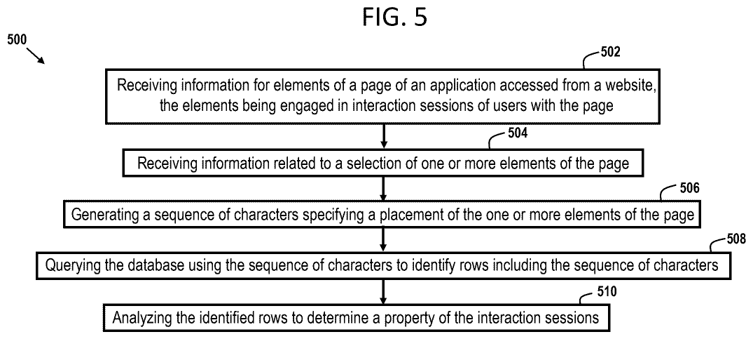

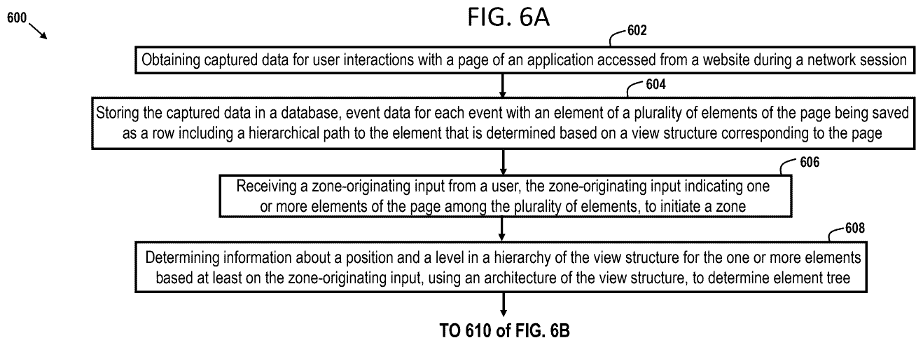

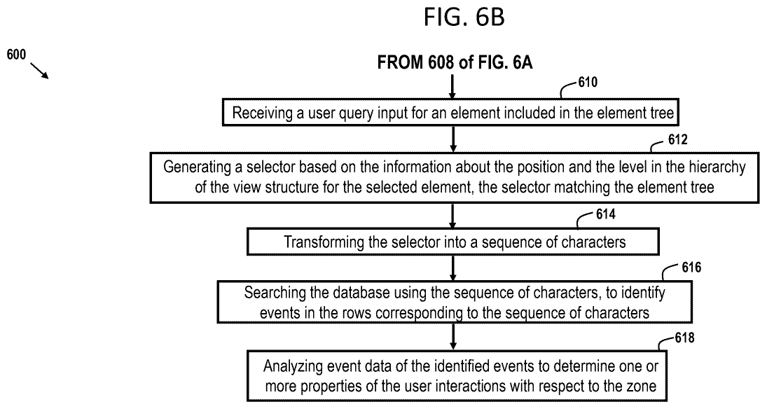

FIG. 5 shows an example of a method of a zoning system for generating a regex for a zone and obtaining information corresponding to regex, where the information is related to the user interactions within the zone. FIGS. 6A and 6B, in combination, show an example of a distributed computer system for capturing and storing the information related to user interactions, defining a zone, generating a regex for a zone, and obtaining information corresponding to regex, where the information is related to the user interactions within the zone.

### A. Method of Zoning System

FIG. 5 shows a simplified block diagram of a processing 500 performed by the zoning system 150 in accordance with various embodiments. The processing 500 may be performed by some or all of the zone defining subsystem 202, the selector generating subsystem 204, the regex generating subsystem 206, and the zone data analyzing subsystem 207. The processing 500 may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 5 and described below is intended to be illustrative and non-limiting. Although FIG. 5 depicts the various processing operations occurring in a particular sequence or order, this is not intended to be limiting. In certain alternative embodiments, the processing 500 may be performed in some different order or some operations may be performed at least partially in parallel.

At operation 502, the zoning system 150 can receive information for elements of a page of an application accessed from a website, the elements being engaged in interaction sessions of users with the website. The information is saved in a database 149 and includes, for each of the elements, information about a node for the element in a view structure of the page, the view structure having a hierarchical tree architecture. The information about the node for the element may include at least one from among information related to a number of mouse clicks received on the element, information about a time that the element received a mouse hovering, and information about a time period that the element was displayed to a user.

The information further includes, for each of the elements, a hierarchical path from the node to a root of the view structure, where an event with an element of the page is saved as a row including the hierarchical path for the element.

At operation 504, the zoning system 150 can receive information about a selection of one or more elements of the page.

For example, the zoning system 150 can display the page, where the selection of the one or more elements is via a graphical user interface in the displayed page.

In some implementations, the zoning system 150 can generate one or more selectors for the one or more elements, respectively, based on the information about a position and a level in a hierarchy of the view structure for the one or more elements.

In some implementations, the zoning system 150 can receive, as a user input that is input in a text field displayed on a display, a user text providing one or more selectors, respectively.

At operation 506, the zoning system 150 can generate a sequence of characters specifying a placement of the one or more elements of the page.

In some implementations, the zoning system 150 can generate the sequence of characters by transforming the one or more selectors into one or more search regular expressions, respectively.

At operation 508, the zoning system 150 can query the database 149 using the sequence of characters to identify one or more rows including the sequence of characters.

At operation 510, the zoning system 150 can analyze the identified rows to determine a property of the interaction sessions. As a non-limiting example, with respect to the element included in the zone, the property can relate to a number of mouse clicks received on the element, a time that the element received a mouse hovering, and/or a time period that the element was displayed to a user during the interaction session.

In embodiments, the zoning system 150 can display metrics related to the property, as an overlay on a replay of the page.

### B. Method of Distributed Computer System

FIGS. 6A and 6B show simplified block diagram of a processing 600 performed by the distributed computer system 100 in accordance with various embodiments. The processing 600 may be performed by some or all of the content delivery system 120, the event capture system 130, and the zoning system 150. The processing 600 may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIGS. 6A and 6B and described below is intended to be illustrative and non-limiting. Although FIGS. 6A and 6B depicts the various processing operations occurring in a particular sequence or order, this is not intended to be limiting. In certain alternative embodiments, the processing 600 may be performed in some different order or some operations may be performed at least partially in parallel.

With reference to FIG. 6A, at operation 602, the distributed computer system 100 can obtain captured data for user interactions with a page of an application accessed from a website during a network session.

At operation 604, the distributed computer system 100 can store the captured data in a database 149, where event data for each event with an element of a plurality of elements of the page is saved as a row including a hierarchical path to the element that is determined based on a view structure corresponding to the page, the view structure having a hierarchical tree architecture.

At operation 606, the distributed computer system 100 can receive a zone-originating input from a user, the zone-originating input indicating one or more elements of the page among the plurality of elements, to initiate a zone.

In embodiments, the distributed computer system 100 can display, on a display screen, the page, and the zone-originating input can be received via a user interface provided on the display screen.

At operation 608, the distributed computer system 100 can determine information about a position and a level in a hierarchy of the view structure for the one or more elements based at least on the zone-originating input, using the hierarchical tree architecture of the view structure to determine an element tree.

The zone-originating input indicating the one or more elements of the page can identify one or more origin elements corresponding to one or more origin nodes of the view structure, and the view structure can be scanned from the one or more origin nodes to one or more roots that are connected to the one or more origin nodes, to determine one or more element trees, respectively.

For example, the zone-originating input can indicate at least two elements (e.g., origin nodes) of the page among the plurality of elements, where the at least two elements are randomly selected, e.g., the at least two elements are discrete elements and can be positioned in the same area or different areas of the display screen.

The zone can be generated based on a rule. As an example, the rule can specify to include into the zone each ancestor node of each of the one or more origin nodes. As another example, the rule can specify to include into the zone at least one sibling node of at least one of the one or more origin nodes.

With reference to FIG. 6B, at operation 610, the distributed computer system 100 can receive a user query input for an element included in the element tree.

In embodiments, the page can be displayed on a display screen, and the user query input can be received via a user interface provided on the display screen.

At operation 612, based on the user query input, the distributed computer system 100 can generate a selector based on the information about the position and the level in the hierarchy of the view structure for the selected element, the selector matching the element tree.

At operation 614, the distributed computer system 100 can transform the selector into a sequence of characters.

At operation 616, the distributed computer system 100 can search the database 149 using the sequence of characters, to identify events in the rows corresponding to the sequence of characters.

At operation 618, the distributed computer system 100 can analyze event data of the identified events to determine one or more properties of the user interactions with respect to the zone, where the event data of the identified events contain data about one or more properties of the user interactions.

In embodiments, the zones can be generated to overlap. In an example, the one or more elements include a first element and a second element respectively corresponding to a first origin node to initiate a first zone and a second origin node to initiate a second zone. The view structure can be scanned from the first origin node to a root connected to the first origin node, and from the second origin node to a root connected to the second origin node, where the root connected to the first origin node is the same as the root connected to the second origin node, the first zone includes a first plurality of elements including the first element, the second zone includes a second plurality of elements including the second element, and the first plurality of elements of the first zone overlap the second plurality of elements of the second zone in an overlap zone including a third plurality of elements. The above-described user query input is a first user query input, the sequence of characters is a first sequence of characters, and the distributed computer system 100 can receive a second user query input for a third element among the third plurality of elements of the overlap zone; based on the second user query input, generate a second selector based on the information about the position and the level in the hierarchy of the view structure for the third element; transform the second selector into a second sequence of characters; search the database using the second sequence of characters, to identify events in rows corresponding to the second sequence of characters; and analyze event data of the identified events to determine properties of user interactions with respect to overlap zone, where the events are identified as having been occurred in the first zone and the second zone, and the event data of the identified events contain data about the properties of the user interactions in the first zone and the second zone.

In embodiments, the distributed computer system 100 can output the information related to the one or more properties to one or more external devices.

In embodiments, the distributed computer system 100 can display metrics related to the one or more properties of the user interactions with respect to the zone, as an overlay on a replay of the page.

Although above embodiments describe separate zone-originating input and user query input, this is not intended to be limiting. In some implementations, the user query input may also serve as a zone-originating input. For example, when a user wants to observe the data related to the operation of the website for a certain element, the user can click on the element of the replay session displayed on the output device 226, thereby providing both zone-originating input and user query input. The disclosed techniques then implement operations as described above.

According to various embodiments, there is provided a system including: one or more processors; and a non-transitory computer-readable medium memory coupled to the one or more processors, the non-transitory computer-readable medium memory storing instructions that, when executed by the one or more processors, cause the one or more processors to perform a method including: receiving information for elements of a page of an application accessed from a website, the elements being engaged in interaction sessions of users with the website, where the information is saved in a database and includes, for each of the elements, (1) information about a node for the element in a view structure of the page, the view structure having a hierarchical tree architecture, and (2) a hierarchical path from the node to a root of the view structure, where an event related to an element of the page is saved as a row including the hierarchical path for the element; receiving information related to a selection of one or more elements of the page of the website; generating a sequence of characters specifying a placement of the one or more elements of the page; querying the database using the sequence of characters to identify one or more rows including the sequence of characters; and analyzing the identified one or more rows to determine a property of the interaction sessions.

According to various embodiments, there is provided a system including: one or more processors; and a non-transitory computer-readable medium memory coupled to the one or more processors, the non-transitory computer-readable medium memory storing instructions that, when executed by the one or more processors, cause the one or more processors to perform a method including: obtaining captured data for user interactions with a page of an application accessed from a website during a network session; storing the captured data in a database, where event data for each event related to an element of a plurality of elements of the page is saved as a row including a hierarchical path to the element that is determined based on a view structure corresponding to the page, the view structure having a hierarchical tree architecture; receiving a zone-originating input from a user, the zone-originating input indicating one or more elements of the page among the plurality of elements, to initiate a zone; determining information about a position and a level in a hierarchy of the view structure for the one or more elements based at least on the zone-originating input, using the hierarchical tree architecture of the view structure, to determine an element tree; receiving a user query input selecting an element included in the element tree; based on the user query input, generating a selector based on the information about the position and the level in the hierarchy of the view structure for the selected element, the selector matching the element tree; transforming the selector into a sequence of characters; searching the database using the sequence of characters, to identify events in the rows corresponding to the sequence of characters; and analyzing event data of the identified events to determine one or more properties of the user interactions with respect to the zone, where the event data of the identified events contain data about the one or more properties of the user interactions.

### V. EXAMPLE COMPUTER SYSTEM

Any of the computer systems mentioned herein may utilize any suitable number of subsystems. Examples of such subsystems are in computer system 10 of FIG. 7. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 7 are interconnected via a system bus 75. Additional subsystems such as a printer 74, keyboard 78, storage device(s) 79, monitor 76 (e.g., a display screen, such as an LED), which is coupled to display adapter 82, and others are shown. Peripherals and input/output (I/O) devices, which couple to I/O controller 71, can be connected to the computer system by any number of means known in the art such as input/output (I/O) port 77 (e.g., USB, Fire Wire®). For example, I/O port 77 or external interface 81 (e.g., Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer-readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g., an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, any related art or object-oriented techniques. The software code may be stored as a series of instructions or commands on a computer-readable medium for storage and/or transmission. A suitable non-transitory computer-readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer-readable medium may be any combination of such storage or transmission devices.

Such programs may also be encoded and transmitted using carrier signals adapted for transmission via wired, optical, and/or wireless networks conforming to a variety of protocols, including the Internet. As such, a computer-readable medium may be created using a data signal encoded with such programs. Computer-readable media encoded with the program code may be packaged with a compatible device or provided separately from other devices (e.g., via Internet download). Any such computer-readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

What is claimed is:

1. A computer-implemented method comprising:
receiving information for elements of a page of an application accessed from a website, the elements being engaged in interaction sessions of users with the website, wherein the information is saved in a database and includes, for each of the elements, (1) information about a node for the element in a view structure of the page, the view structure having a hierarchical tree architecture, and (2) a hierarchical path from the node to a root of the view structure, wherein an event related to an element of the page is saved as a row including the hierarchical path for the element;
receiving information related to a selection of one or more elements of the page of the website;
generating a sequence of characters specifying a placement of the one or more elements of the page;
querying the database using the sequence of characters to identify one or more rows including the sequence of characters; and
analyzing the identified one or more rows to determine a property of the interaction sessions.

2. The computer-implemented method of claim 1, further comprising:
displaying the page, wherein the selection of the one or more elements is via a graphical user interface in the displayed page.

3. The computer-implemented method of claim 1, wherein the information about the node for the element comprises at least one from among information related to a number of mouse clicks received on the element, information about a time that the element received a mouse hovering, and information about a time period that the element was displayed to a user.

4. The computer-implemented method of claim 1, wherein:
the information for the elements of the page comprises information about a position and a level in a hierarchy of the view structure, for the one or more elements,
the computer-implemented method further comprises, prior to the generating the sequence of characters, generating one or more selectors for the one or more elements, respectively, based on the information about the position and the level in the hierarchy of the view structure for the one or more elements, and
the generating the sequence of characters further comprises transforming the one or more selectors into one or more search regular expressions, respectively.

5. The computer-implemented method of claim 1, wherein:
the receiving the information related to the selection of the one or more elements further comprises receiving, as a user input that is input in a text field displayed on a display, a user text providing one or more selectors, respectively, and
the generating the sequence of characters further comprises transforming the one or more selectors into one or more search regular expressions, respectively.

6. The computer-implemented method of claim 1, further comprising:
displaying metrics related to the property, as an overlay on a replay of the page.

7. A computer-implemented method comprising:
obtaining captured data for user interactions with a page of an application accessed from a website during a network session;
storing the captured data in a database, wherein event data for each event related to an element of a plurality of elements of the page is saved as a row including a hierarchical path to the element that is determined based on a view structure corresponding to the page, the view structure having a hierarchical tree architecture;
receiving a zone-originating input from a user, the zone-originating input indicating one or more elements of the page among the plurality of elements, to initiate a zone;
determining information about a position and a level in a hierarchy of the view structure for the one or more elements based at least on the zone-originating input, using the hierarchical tree architecture of the view structure, to determine an element tree;
receiving a user query input selecting an element included in the element tree;
based on the user query input, generating a selector based on the information about the position and the level in the hierarchy of the view structure for the selected element, the selector matching the element tree;
transforming the selector into a sequence of characters;
searching the database using the sequence of characters, to identify events in the rows corresponding to the sequence of characters; and
analyzing event data of the identified events to determine one or more properties of the user interactions with respect to the zone,
wherein the event data of the identified events contain data about the one or more properties of the user interactions.

8. The computer-implemented method of claim 7, further comprising:
outputting information related to the one or more properties to one or more external devices.

9. The computer-implemented method of claim 7, further comprising:
displaying, on a display screen, the page,
wherein the zone-originating input is received via a user interface provided on the display screen.

10. The computer-implemented method of claim 7, further comprising:
displaying, on a display screen, the page,
wherein the user query input is received via a user interface provided on the display screen.

11. The computer-implemented method of claim 7, wherein the zone-originating input indicating the one or more elements of the page identifies one or more origin elements corresponding to one or more origin nodes of the view structure, and
wherein the view structure is scanned from the one or more origin nodes to one or more roots that are connected to the one or more origin nodes, to determine one or more element trees, respectively, the element tree being one of the one or more element trees.

12. The computer-implemented method of claim 7, wherein:
the zone-originating input indicates at least two elements of the page among the plurality of elements,
the at least two elements are randomly selected, and
the one or more elements are included in the at least two elements.

13. The computer-implemented method of claim 7, further comprising:
generating the zone based on a rule.

14. The computer-implemented method of claim 13, wherein the rule specifies to include into the zone each ancestor node of each of one or more origin nodes corresponding to the one or more elements.

15. The computer-implemented method of claim 13, wherein the rule specifies to include into the zone at least one sibling node of at least one of one or more origin nodes corresponding to the one or more elements.

16. The computer-implemented method of claim 7, wherein:
the one or more elements include a first element and a second element respectively corresponding to a first origin node to initiate a first zone and a second origin node to initiate a second zone, the zone being the first zone,
the view structure is scanned from the first origin node to a root connected to the first origin node, and from the second origin node to a root connected to the second origin node,
the root connected to the first origin node is the same as the root connected to the second origin node,
the first zone comprises a first plurality of elements comprising the first element,
the second zone comprises a second plurality of elements comprising the second element, and
the first plurality of elements of the first zone overlap the second plurality of elements of the second zone in an overlap zone comprising a third plurality of elements.

17. The computer-implemented method of claim 16, wherein the user query input is a first user query input,
the sequence of characters is a first sequence of characters, and
the computer-implemented method further comprises:
receiving a second user query input for a third element among the third plurality of elements of the overlap zone;
based on the second user query input, generating a second selector based on the information about the position and the level in the hierarchy of the view structure for the third element;
transforming the second selector into a second sequence of characters;
searching the database using the second sequence of characters, to identify events in rows corresponding to the second sequence of characters; and
analyzing event data of the identified events to determine properties of user interactions with respect to overlap zone,
wherein the identified events are identified as having been occurred in the first zone and the second zone, and
the event data of the identified events contain data about the properties of the user interactions in the first zone and the second zone.

18. The computer-implemented method of claim 7, further comprising:
displaying metrics related to the one or more properties of the user interactions with respect to the zone, as an overlay on a replay of the page.

19. A system comprising:
one or more processors; and
a non-transitory computer-readable medium memory coupled to the one or more processors, the non-transitory computer-readable medium memory storing instructions that, when executed by the one or more processors, cause the one or more processors to perform a method including:
receiving information for elements of a page of an application accessed from a website, the elements being engaged in interaction sessions of users with the website, wherein the information is saved in a database and includes, for each of the elements, (1) information about a node for the element in a view structure of the page, the view structure having a hierarchical tree architecture, and (2) a hierarchical path from the node to a root of the view structure, wherein an event related to an element of the page is saved as a row including the hierarchical path for the element;
receiving information related to a selection of one or more elements of the page of the website;
generating a sequence of characters specifying a placement of the one or more elements of the page;
querying the database using the sequence of characters to identify one or more rows including the sequence of characters; and
analyzing the identified one or more rows to determine a property of the interaction sessions.
